(19) United States
(12) Patent Application Publication
(10) Pub. No.: US 2005/0010630 A1
(43) Pub. Date: Jan. 13, 2005

(54) Method and apparatus for determining a remainder in a polynomial ring

(75) Inventors: Andreas Doering, Adliswil (CH); Marcel Waldvogel, Winterthur (CH)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: International Business Machines Corporation, Armonk, NY (US)

(21) Appl. No.: 10/844,798

(22) Filed: May 13, 2004

(30) Foreign Application Priority Data
May 13, 2003 (EP) 03405331.4

(51) Int. Cl. G06F 11/10

(52) U.S. Cl. 708/490

(57) ABSTRACT

The present invention relates to a method and an apparatus for determining a remainder in a polynomial ring.

The apparatus for determining a remainder in a polynomial ring according to the invention comprises a value buffer (18) for storing a polynomial value, a factor memory (8.1, 8.2) for storing factors and a polynomial multiply unit (1) connected to the factor memory (8.1, 8.2) for generating a polynomial product out of the factors and an input polynomial. The apparatus further comprises a matrix multiply unit (5) connected to the polynomial multiply unit for generating a reduced product with reduced polynomial degree by multiplying the polynomial product with a reduction matrix. Finally the apparatus includes a multiplexer means (13.1, 13.2, 17, 39.1, 39.2) for either conducting the reduced product or the polynomial value as the input polynomial to the to the polynomial multiply unit (1).

### CROSS-REFERENCE TO RELATED APPLICATIONS

This application claims benefit of European patent application number 03405331.4, filed May 13, 2003, which is herein incorporated by reference.

### TECHNICAL FIELD

The present invention relates to a method and an apparatus for determining a remainder in a polynomial ring.

In general, the computation in polynomial remainder rings is currently intensively used for hashing, integrity checksums, message digests and as pseudo random number generators. If the polynomial remainder rings are used as checksums they are called cyclic redundancy check (CRC).

### BACKGROUND OF THE INVENTION

Cyclic redundancy checks are increasingly used in communication protocols and distributed software. For example, in communication networks in which data are sent in frames from an originating source terminal via a network including several intermediate nodes to a destination terminal data integrity is a major concern. The data integrity is secured on links from node to node by means of a frame check sequence (FCS) using the cyclic redundancy check. This frame check sequence is generated at the transmitting site to be data dependent according to a predetermined relationship. The generated transmission frame check sequence FCSt with t standing for transmit is appended to the transmitted data. Data integrity at the receiving terminal is then checked by deriving from the received data a receive frame check sequence FCSr with r standing for receive and comparing the receive frame check sequence FCSr to the transmission frame check sequence FCSt to check for identity or processing complete frames. For the calculation of the receive frame check sequence FCSr a process similar to the one generating the transmission frame check sequence FCSt is used. Any invalid detection leads to a mere discard of the received data frame and the initiation of a procedure established to generate retransmission of same data frame until validity is checked.

A basic parameter of a cyclic redundancy check is the generating polynomial p. Typically generating polynomials p over the Galois field of order 2, GF(2), are applied with degrees of 8, 16, 32 and more, recently also 64. Different communication protocols use different generating polynomials p of different degrees. Therefore a standard device like a network processor should be able to work with different generating polynomials p. With the increasing number of protocols supported by a given end system, multiple generating polynomials p need to be selected in quick succession. As protocols are used on top of other protocols, the processing device needs to work on multiple generating polynomials p at the same time, e.g. iSCSI over SCTP over Ethernet.

In the prior art EP 0 313 707 a data integrity securing means for a communication network is described, in which data are sent in frames. For the calculation of a CRC a multiplier is provided in the data integrity securing means. When more than two contiguous bytes of the frame differ, each byte pair requires a complex and time expensive series of multiply steps. Also if more than two not adjacent bytes of the frame differ, the single byte requires a complex and time expensive series of multiply steps. Disadvantageously, the calculation of the CRC is quite inefficient and time expensive. Another disadvantage consists in the fact, that the data integrity securing means according to the prior art is not able to handle different generating polynomials.

In Gutman et al. U.S. Pat. No. 5,428,629 an error check code recomputation method time independent of message length is described. The error check code recomputation method is used in a data packet communication network capable of transmitting a digitally coded data packet message including an error-check code from a source node to a destination node over a selected transmission link. The transmission link includes at least one intermediate node operative to intentionally alter a portion of a message to form an altered message which is ultimately routed to the destination node. The described method recomputes at the intermediate node a new error-check code for the altered message with a predetermined number of computational operations, i.e. computational time, independent of the length of the message, while the integrity of the initially computed error-check code of the message is preserved. Disadvantageously, it is required that the check polynomial is irreducible. However, this is not the case for a series of important standard check polynomials. For instance, popular polynomials contain a factor of (x+1) to include parity computation. Another disadvantage consists in the fact, that the data integrity securing means according to the prior art is not able two handle different generating polynomials.

The frame check sequence generation is performed through a complex processing operation involving polynomial divisions performed on all the data contained in a frame. These operations need high computing power and add processing load to the transmission system. Any method for simplifying the frame check sequence generation process would be welcome.

According to one object of the invention, a method for determining a remainder in a polynomial ring and an apparatus for determining a remainder in a polynomial ring are proposed, which make the determination of the remainder in the polynomial ring faster.

A second object of the invention is to form the method and the apparatus in such a way, that it is possible to handle different generating polynomials with which different polynomial remainders can be generated. Advantageously the different polynomial remainders can be generated simultaneously.

### SUMMARY OF THE INVENTION

According to aspects of the invention, the objects are achieved by a method for determining a remainder in a polynomial ring with the features of the independent claim 1, by a method for updating the checksum in a data frame with the features of the independent claims 5 and 6, by an apparatus for determining a remainder in a polynomial ring with the features of the independent claim 7 and by a computer program product with the features of the independent claim 12.

The method for determining a remainder in a polynomial ring according to the invention comprises the following steps.
a1) Extract a value out of a quantity of values, in which each value has a certain position.
b) Determine from the position of the first value a set of factors.
c) Calculate the product from a first and a second factor, which are taken from the set of factors.
d) Split the product into an upper product part and a lower product part.
e) Reduce the upper product part by multiplying the upper product part with a reduction matrix.
f) Join the lower product part and the result from step e) together to get a reduced product.
g) Calculate the product from the reduced product and the next factor out of the set of factors.
h) Repeat the steps d) to g) for all factors from the set of factors.
i) Calculate the product from the reduced product and the extracted value.
j) Repeat the steps d) to f), wherein the last preserved reduced product is the remainder in the polynomial ring.

The method for updating the checksum in a data frame, including an original polynomial section to be replaced by a new polynomial section, comprises the steps of:
a) Calculate the difference polynomial between the original polynomial section and the new polynomial section.
b) Determine from the position of the original polynomial section a set of factors.
c) Calculate the product from a first and a second factor, which are taken from the set of factors.
d) Split the product into an upper product part and a lower product part.
e) Reduce the upper product part by multiplying the upper product part with a reduction matrix.
f) Join the lower product part and the result from step e) together to get a reduced product.
g) Calculate the product from the reduced product and the next factor out of the set of factors.
h) Repeat the steps d) to g) for all factors from the set of factors.
i) Calculate the product from the reduced product and the polynomial difference.
j) Repeat the steps d) to f).
k) Finally add the last preserved reduced product to the original checksum to generate the updated checksum.

The method for updating the checksum in a data frame according to the invention, wherein the data frame includes a first subframe with a checksum CS(A) to be enlarged by a second subframe with a checksum CS(B), includes the following steps.
a) Determine from the position of the checksum CS(A) a set of factors.
b) Calculate the product from a first and a second factor, which are taken from the set of factors.
c) Split the product into an upper product part and a lower product part.
d) Reduce the upper product part by multiplying the upper product part with a reduction matrix.
e) Join the lower product part and the result from step e) together to get a reduced product,
f) calculate the product from the reduced product and the next factor out of the set of factors.
g) Repeat the steps d) to f) for all factors from the set of factors.
h) Calculate the product from the reduced product and the checksum CS(A).
i) Repeat the steps d) to f).
j) Finally add the last preserved reduced product to the checksum CS(B) to generate the updated checksum CS(A, B).

The apparatus for determining a remainder in a polynomial ring according to the invention comprises a value buffer for storing a polynomial value, a factor memory for storing factors and a polynomial multiply unit connected to the factor memory for generating a polynomial product out of the factors and an input polynomial. The apparatus further comprises a matrix multiply unit connected to the polynomial multiply unit for generating a reduced product with reduced polynomial degree by multiplying the polynomial product with a reduction matrix. Finally the apparatus includes a multiplexer means for either conducting the reduced product or the polynomial value as the input polynomial to the to the polynomial multiply unit.

The computer program product according to the invention is loadable into the internal memory of a digital computer and comprises software code portions for performing the steps of:
a) Extract a value out of a quantity of values, in which each value has a certain position.
b) Determine from the position of the first value a set of factors.
c) Calculate the product from a first and a second factor, which are taken from the set of factors.
d) Split the product into an upper product part and a lower product part.
e) Reduce the upper product part by multiplying the upper product part with a reduction matrix.
f) Join the lower product part and the result from step e) together to get a reduced product.
g) Calculate the product from the reduced product and the next factor out of the set of factors.
h) Repeat the steps d) to g) for all factors from the set of factors.
i) Calculate the product from the reduced product and the extracted value.
j) Finally repeat the steps d) to f), wherein the last preserved reduced product is the remainder in the polynomial ring.

Advantageous further developments of the invention arise from the characteristics indicated in the dependent patent claims.

In an embodiment of the method for determining a remainder in a polynomial ring the method comprises the further steps:
a) Before step a1) is worked off, a current remainder is initialized to a predefined constant value.
k) After step j) the last preserved reduced product is added to the current polynomial remainder.

l) Finally, the steps a1) to k) are repeated until all values are exhausted.

Preferably, in the method for determining a remainder in a polynomial ring the factors are determined and stored in a factor memory before the calculation of the reduced product is started.

In another embodiment of the method according to the invention the preserved reminder in the polynomial ring is used as checksum.

In another embodiment of the apparatus for determining a remainder in a polynomial ring a matrix memory is provided for storing the reduction matrix.

In a further embodiment of the apparatus for determining a remainder in a polynomial ring the reduction matrix is stored as compressed reduction matrix in the matrix memory. The apparatus further comprises a decompression unit connected between the matrix memory and the matrix multiply unit for decompressing the compressed reduction matrix.

For solving the object of the invention it is suggested that the apparatus includes a buffer for storing several remainders in polynomial rings and an adder for adding the remainders. This is particularly helpful when for example a data frame shall be enlarged by several subframes. Therefore the remainder in the polynomial ring, which can be used as checksum, can be stored for each new subframe in the buffer. After computation of all remainders for all additional subframes, the remainders stored in the buffer can be added to a final remainder or checksum. The suggested embodiment is also helpful when several sections in a data frame shall be altered. In this case, also all remainders for all altered sections are stored in the buffer. Afterwards the stored remainders are added to generate a final remainder representing the checksum for the new data frame.

Finally the apparatus according to the invention may include a rotation unit connected between the polynomial multiply unit and the matrix multiply unit for mixing up the outputs of the polynomial multiply unit, if required. With this, the complexity of the polynomial reduction can be kept low. The rotation unit helps to decrease the polynomial degree of the polynomial product at the output of the polynomial multiply unit. The mixing up of the outputs is carried out, when sufficiently many zero values appear in the polynomial product at the right place.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 the structure of a typical data packet message protocol, which may be transmitted over a transmission link of a communication network,

FIG. 2 a schematic block diagram of the checksum calculator according to the invention,

FIG. 3 a first possible implementation of the method for determining a remainder in a polynomial ring,

FIG. 4 a second possible implementation of the method for determining a remainder in a polynomial ring,

FIG. 5 a third possible implementation of the method for determining a remainder in a polynomial ring,

FIG. 6 a fourth possible implementation of the method for determining a remainder in a polynomial ring,

FIG. 7 a diagram for explanation of the motivation for a position management,

FIG. 8 the reduction process for reducing the polynomial degree.

FIG. 9 a more detailed block diagram of the checksum calculation unit according to the invention,

FIG. 10 an optional rotation unit for a simpler handling of the product polynomials, which can be inserted after the polynomial multiply unit.

FIG. 11 a first embodiment of an application in which an original data word is replaced by a new data word using the checksum calculation unit according to the invention to recalculate the checksum and

FIG. 12 a second embodiment of an application in which a first subframe is added to a second subframe using the checksum calculation unit according to the invention to recalculate the checksum.

### DETAILED DESCRIPTION OF THE DRAWINGS

Though the following explanations relate to checksums the invention is not restricted on it. The invention can be used for the computation in polynomial remainder rings, e.g. for hashing, integrity checksums, message digests, storage applications, version control and as pseudo random number generators.

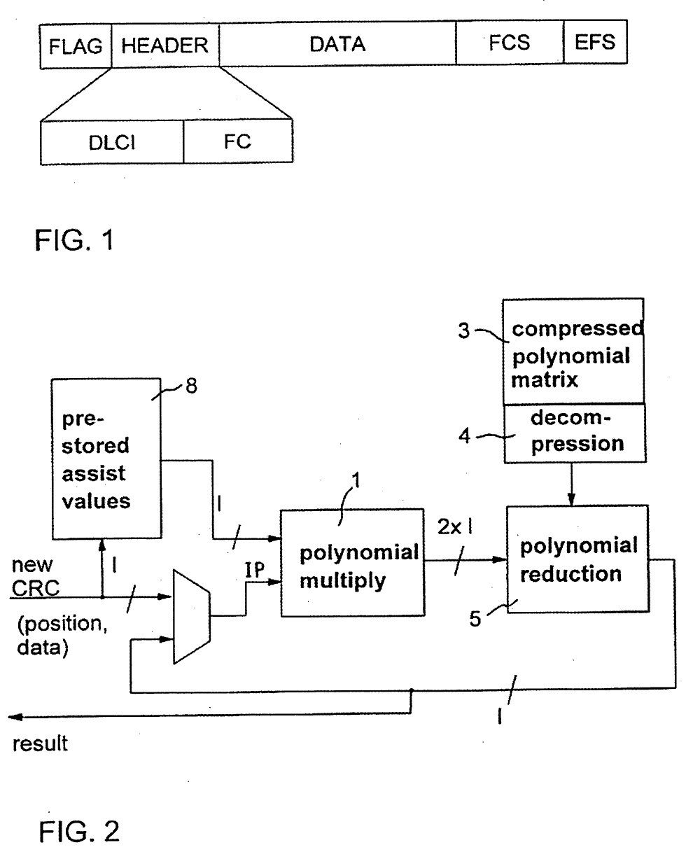

Also, in a number of applications, the transmitted message frame includes information data, and a so-called header made to help the transmitted frame find its way from node to node within the network up to the destination terminal. In FIG. 1 is illustrated a typical data packet message protocol which is conventionally transmitted over a transmission link in a digital bit sequence manner. The sample message protocol used in this description is based on High-level data link control HDLC, documented in ISO 3309, which is incorporated herein by reference. The message protocol commences with a frame delimiting field which is denoted with FLAG and which may have a field length of approximately 8 bits. The next field in succession is referred to as the header field HEADER and comprises on the order of 3 bytes. The data field DATA follows and is generally variable in length including anywhere from 1 byte to 8,000 bytes, for example. The next field in succession is referred to as the frame check sequence field FCS and normally includes the CRC error check code which may be on the order of 16 to 32 bits in length. The message sequence ends with an ending flag field EFS of say 8 bits. In many applications, the header field HEADER comprises a data link identifier DLCI on the order of 2 to 3 bytes and a frame control sub-field FC of approximately 8 bits. Normally in a data packet or frame relay communication system, it is the data link identifier field DLCI or portion thereof of the message which is altered. For example, the data link identifier field DLCI in the frame may be removed and a new data link identifier field DLCI may be inserted in the frame. Thus, it is this alteration which requires modification of the CRC error check code within the frame cheek sequence field FCS field of the data message. Therefore, the frame check sequence is modified in each node for instance by inserting in the message to be forwarded the address of subsequent node in the network. All these operations do therefore affect the message frame and thus, the FCS needs to be regenerated in each node. This means that the FCS generation process needs to be implemented several times on each message flowing in the transmission network which emphasizes the above comments on usefulness of simplified FCS generation schemes.

When the data frames or data units are transferred through the network, it can happen that small parts of the message have to be modified, for instance an address is translated or a special field is decremented. An example is the time-to-live field in the Internet Protocol (IPv4).

Therefore, there are currently mainly four main tasks involving checksum calculation:
1. A data block without a checksum is given. The checksum of the data block has to be computed.
2. A new data block is created word by word and the checksum has to be computed.
3. A data block with a valid checksum is given. Some words in the data block are changed. A new checksum has to be created, which is valid after applying these changes. The old value of the checksum can be reused. If the original checksum was invalid, the operation may be performed as well, but the resulting checksum should again be invalid, so the transmission error can be correctly detected by the ultimate receiver.
4. Several data blocks with valid checksums are given. A new data block is created by concatenating the given data blocks. A checksum for the new data block is needed. The same rule applies for invalid checksums.

The checking of the validity of a checksum is similar to the creation of a checksum. However, when the checksum is invalid there are several options. There are methods, which try to guess the reason for a checksum error, for example robust header compression (ROHC) and IETF RFC 3095. This requires several minor modifications to the same block and tests for the checksum validity. It is similar to multiple applications of the third checksum creation task.

The method and apparatus of this invention is universal in the sense that it can solve all four above mentioned problems through a uniform architecture with the flexibility to support several polynomials at the same time with comparatively low cost. Several checksum computations can be carried out concurrently. For instance, several blocks can be handled by several of the tasks at the same time by applying commands to the blocks in arbitrary order.

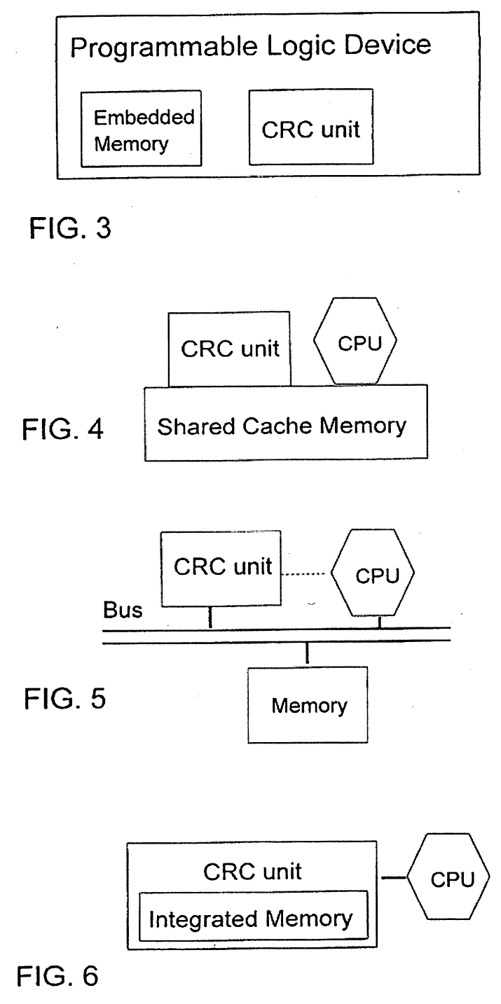

The method according to the invention can be implemented purely in software or with varying amounts of hardware depending on the required performance and flexibility. As shown in FIG. 5, a hardware implementation can be used as a coprocessor to a CPU in the same way it was typical for floating point in the past. Alternatively as shown in FIGS. 4 and 6, the CRC unit can work autonomously with an appropriate source for data and commands. Finally as illustrated in FIG. 3, it can be integrated with other configurable circuitry like a programmable logic device. Of course, the method can be implemented with the resources of a programmable logic device. These options are illustrated as follows:

The method includes a mechanism for decoupling the reception of commands and computation while making use of properties of the computations involved to reduce the overall processing amount if a high rate of commands is present. Knowledge about a given application can be incorporated transparently. This covers especially the cases of fixed data block sizes in the above mentioned task 4 or fixed positions in task 3. This knowledge can speed up the computation and reduce the power consumption. However, the performance in the general case is very high. The method can reuse computations efficiently: Similarities in the computations can be exploited for a high performance and low power. For instance, if an application requires the checksum update after a change at only one position to several blocks, each result but the first can be delivered in very few clock cycles. The method can work in two modes depending the way the position in the frame is specified.

The method works in parallel on several digits organized as words. Such a word has a typical word width w of 8, 16, 32 or 64 bits. At several points in the computation also words with double size are needed. The method can be used with several different word sizes w at different positions. The parameters of the typical operations like modification of a block are given in words as well.

In the following, the calculation of the checksum for the frame check sequence is further explained.

The computing unit, shown in FIG. 2, supports a not shown central processing unit (CPU) in computations of entire or incremental CRC checksums. For example, the computing unit may support up to 16 simultaneously ongoing 32 bit CRC calculations with four different generating polynomials p. Different generating polynomials p are defined in communication standards. For example, the CCITT CRC-16 standard defines the generating polynomial p as follows:
p=x¹⁶+x¹²+x⁵+1
whereas the CCITT CRC-32 standard defines the generating polynomial p as:
p=x³²+x³¹+x⁴+x+1
and the CRC32Q standard, which is used in iSCSI, defines the generating polynomial p as follows:
p=x³²+x³¹+x²⁴+x²²+x¹⁶+x¹⁴+x⁸+x⁷+x⁵+x³+x³³+1

The above mentioned communication standards are only a selection of possible communication standards and serve as examples for explanation of the generating polynomial p. In the following, the generating polynomial p is also called check polynomial.

As shown in FIG. 2, the computing unit comprises a factor memory 8, in which assist values called factors are stored. A polynomial multiply unit 1 multiplies this factors iteratively with an input polynomial IP. The input polynomial IP is either a reduced product resulting from a polynomial reduction unit 5 or a polynomial value called data received at the input of the computing unit. For reducing the polynomial product generated by the polynomial multiply unit 1 the polynomial reduction unit 5 multiplies the polynomial product by a reduction matrix. For the matrix multiplication the polynomial product is interpreted as vector. A compressed version of the reduction matrix is stored in a matrix memory 3. With the help of a decompression unit 4 the compressed reduction matrix is decompressed and conducted to the polynomial reduction unit 5. The matrix memory 3 may store different reduction matrices. Which reduction matrix is used may depend on the generating polynomial p. After iteratively working off all relevant factors and finally multiplying the polynomial product with the data from the input of the computing unit the result is available at the output of the reduction unit 5 as remainder in the polynomial ring. This remainder may be used for example as checksum.

This CRC support is intended for higher protocol layers which are not covered by lower layer modules like a Media Access Controller. On these higher protocol layers a protocol implementation in software includes CRC computations on fractions of frames. Which fraction for this is used depends on the situation in the protocol. An example for this is the ROHC. Here, the checksum is computed over the restored packet fields after decompression and the checksum is used to detect decompression errors.

An advantage of the apparatus and the method according to the invention is, that with the help of an incremental CRC calculation the calculation of the new checksum is very effective, if a CRC checksum over a certain data block already exists, but an incremental portion of the data block has to be modified. This is typically done then when part of the frame address of a packet is altered or the time to life field is decremented. With the incremental CRC calculator the checksum does not have to be recalculated over the entire data block, but the method and the apparatus according to the invention directly combine the incremental data change with the previous CRC checksum. When a new block is constructed, the data can be fed to the CRC calculation as it is generated such that most of the calculation is already completed when the last data item is written. Block-wise CRC generation or checking is of course possible and is efficiently supported. Another typical use of the method and the apparatus according to the invention is the concatenation of data blocks to form a larger frame. When the CRC of the parts is already known or computed at a suitable earlier point in time, the determination of the CRC of the compound block is very fast.

The CRC computation core according to the invention offers a high flexibility to the software. First, this is achieved by different functions for tracking the checksum when a frame is punctually modified, as already described in the previous section. Second, this is achieved by the support of a set of arbitrary polynomials up to a certain degree. The CRC computation core supports any polynomial up to a maximum degree, e.g. up to a degree of 32. Third, this is achieved by the possibility to mix generating polynomials of different degrees. For example, the coprocessor can be configured such that the communication standards CRC32Q, which is used in iSCSI, CCITT CRC-32, CCITT CRC-16 and CCITT CRC-8 are supported simultaneously. The configuration can be exchanged at run-time. The commands using different polynomials can be arbitrarily mixed. Thus, that several generating polynomials can be used simultaneously.

In order to reduce the amount of communication between the coprocessor and main processor, the checksum is accumulated in the coprocessor. In order to support different checksum accumulations at the same time, a set of checksum accumulation registers CAR is provided. The typical layout of data and use of checksums is such that the checksum computation starts at the beginning of a packet and the result is appended at the end. This has the effect that the contribution of a given word at a certain position in the frame depends on the distance to the end of the frame and not by the position as measured from the beginning. In environments with variable frame length the application has to provide the length of the checked frame to the coprocessor. This can happen anytime before the result is required.

Furthermore, an addressing unit u for presenting the position in the frame can be either words or smaller, including single bits. This allows the use of non-word aligned contributions to be handled with single operations.

In a preferred embodiment of the invention the CRC parameters have the following values. The number of checksum accumulation registers CAR is 16. The number m of simultaneously supported generating polynomials p is 4. The maximum length L of supported generating polynomial is 32 bit and the maximum block length BL over which a CRC is calculated is 64 k words. The maximum frame length is fixed because it determines the size of the position parameters and accordingly of some internal registers.

The following table summarizes the CRC calculation instructions.

| Instruction | Parameters | Description |
|---|---|---|
| CSCPCLR | CAR, RA | Associates a CRC polynomial (indicated |
| | | in RA) with a CAR and clears the CAR. |
| | | Used to start a new checksum calculation |
| CSCLR | CAR, RT | Load CAR content to RT |
| CSCSP | CAR, RA | Checksum calculator set: Indicates |
| | | the position where the next change |
| | | within the block takes place |
| CSCA | CAR, RA | Calculate update for CAR checksum |
| | | register with word stored in RA at |
| | | current position. The current |
| | | position is automatically incremented. |

In the following, the operation principle of the method and the apparatus according to the invention is further explained. For CRC calculation a data frame is interpreted as a frame polynomial f with coefficients in the Galois field of order 2 GF(2), a Galois field with two elements, wherein “AND” is a multiplication and “XOR” an addition of the field elements. The checksum is the remainder r of dividing this frame polynomial f by a given check or generating polynomial p. This remainder r, which can be used as checksum, has a lower degree than the frame polynomial p:
r=f(mod p)

If the original frame polynomial f is modified at position t by replacing an old value f[t] by a new one f′[t] a new frame polynomial f′ results. To determine the checksum r′ of the new frame polynomial f′, the delta d:
d=f′[t]XORf[t]
is inspected. The impact of delta d on the checksum of the new frame polynomial f′ is:
dr=d·x^{u(1-t)}(mod p)
wherein
dr is the partial checksum or change of the checksum,
u is the addressing unit presenting the position in the frame,
t is the position, where the original frame f has been changed, measured from the start, and
l is the length of the frame.

In the above mentioned equation for calculating the partial checksum dr, u<=w, wherein w is the word width, e.g. w=32 when the position t refers to word addresses.

Therefore 1−t is the distance to the end, where a sequential checksum calculation would stop. The new checksum r′ is calculated with the following equation:
r′=r+dr
r′=f′(mod p)=r+x^{u(1-t})·d(mod p)

To simplify and accelerate the calculation of the new checksum r′ fixed scaling factors Fi are used. These fixed scaling factors Fi are calculated by means of a general purpose computer or coprocessor according to the following equation in advance and stored in a memory provided for the fixed scaling factors Fi.
Fi=x^{u-2}^{ⁱ}(mod p)
wherein
i is the number of the row in the factor memory 8.1 or 8.2.

It is known in the state of the art how fixed scaling factors Fi can be calculated. Therefore, it is referred to the appropriate state of the art as far as the calculation of factors Fi is concerned.

In order to accelerate the computation of the new checksum r′ several methods are combined.
1. Words of size w are processed in one step. The degree of the generator polynomial is less or equal to word width w.
2. The powers
   x^{u(2}^{ⁱ⁾}(mod p)
   are precomputed and stored in the coprocessor. In this way x^{u(1-t)} can be computed by multiplying those precomputed factors, for which the appropriate bit in (1−t) is set.
3. The multiplication of two polynomials with a degree less than the word size w is implemented directly in hardware. The result is a polynomial with degree less than or equal 2*w−2.
4. The reduction (mod p) to a polynomial of degree less than the word size w is done by regarding the higher bits of the polynomial product of the previous step as a vector and multiplying it with a matrix which depends on the check polynomial p. This vector-matrix-multiply is also implemented in hardware. This is illustrated in the following FIG. 2.

In order to support several check polynomials p at once, several sets of precomputed factors are needed as well as several matrices. Since the matrix is typically quite large, only one matrix for the current computation is held in a register and the other matrices are stored in a compressed way in a memory. The compression has two purposes, it reduces the amount of storage in the CRC core needed per check polynomial p and it reduces the time to switch between the check polynomials p because fewer words have to be read from the memory compared to an uncompressed matrix.

In the following, the programming model is described. The main assumption for the programming model is that there are typically several contributions to one checksum, e.g. several modifications to a frame.

From the CRC coprocessor the sequence of operations looks like this: INIT
contribution(address, modification)
contribution(address, modification)
contribution(address, modification)
. . .
contribution(address, modification)/*the last one*/
get_result

The CRC coprocessor has a certain throughput it can achieve and the main processor should interleave normal instructions with CRC instructions to avoid overloading of the CRC coprocessor.

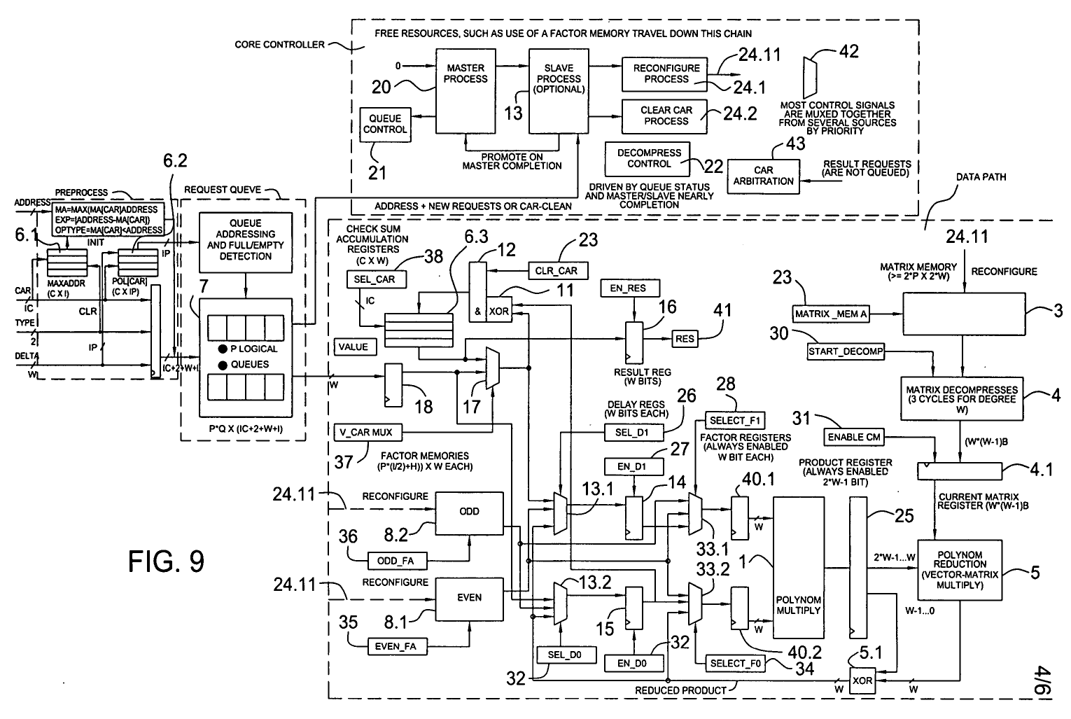

FIG. 9 shows a more detailed block diagram of the checksum calculator according to the invention.

Polynomial Computation Processes

The input to the unit is a sequence of commands and the output delivers reduced polynomials on request. If needed, several polynomial computations can be handled concurrently in different residue rings. This means that for each computation process a polynomial for the definition of the residue ring has to be provided. A typical implementation would provide a fixed set of polynomials beforehand and the appropriate one is selected at the start of a computation. Each command refers to one or several computation processes. A polynomial computation process constructs one polynomial modulo the generator polynomial of the associated remainder ring. A polynomial computation process is started by setting the polynomial to a fixed value, often 0. Following commands modify the value of the computation process. Two basic commands can be used in an polynomial calculation process:
F(c, d):v′:=v*x^{c}+d modulo p
B(c, d):v′:=v+d*x^{c}modulo p
wherein
F(c, d) is the “forward” operation,
B(c, d) is the “backward” operation,
v is the value of computation process before the command,
c and d are parameters of the command,
p is the generator polynomial,
v′ is the new value as result of the command, and
x is and always remains undefined (required for polynomial operations).

If the commands use multi-digit words as parameters, the parameter c of each command has to be an integer multiple of the number of digits in a word. A digit refers here to the base field of the polynomial ring. For the important case of the Galois field with 2 elements GF(2) as base field a digit is a bit. The operations all take place in the Galois field GF(2), so addition, multiplication, and exponentiation do not have their usual meaning. The parameter in the command can be coded appropriately, e.g. giving encoding c divided by the word length w.

For the checksum computation application the two commands F(c, d) and B(c, d) can be interpreted as follows. F(c, d) is the operation of appending a block of data of length c to a partially constructed block with known checksum v. The appended data block has the checksum d. Hence, this operation can be used for the above mentioned tasks 1, 2 and 4. The second operation B(c, d) is symmetric to F(c, d), only the orientation is reversed. Hence, it relates to putting a new data block in front of an existing one. This is identical to modifying a data block containing only zero at the position c, or because of linearity of the operation, modifying a data block at position c from an old value a to a new value a+d using GF(2) arithmetic. The second operation B(c, d) can be used for all four tasks. Only one of the two commands F(c, d) or B(c, d) has to be supported. It should be noted, that the two operations F(c, 0) and B(c, 0) do not change the state of a polynomial computation process, for any c.

Position Management

For many applications it is more convenient to add a position management. The position management accepts a different set of commands and translates them into a polynomial computation process command as described before.

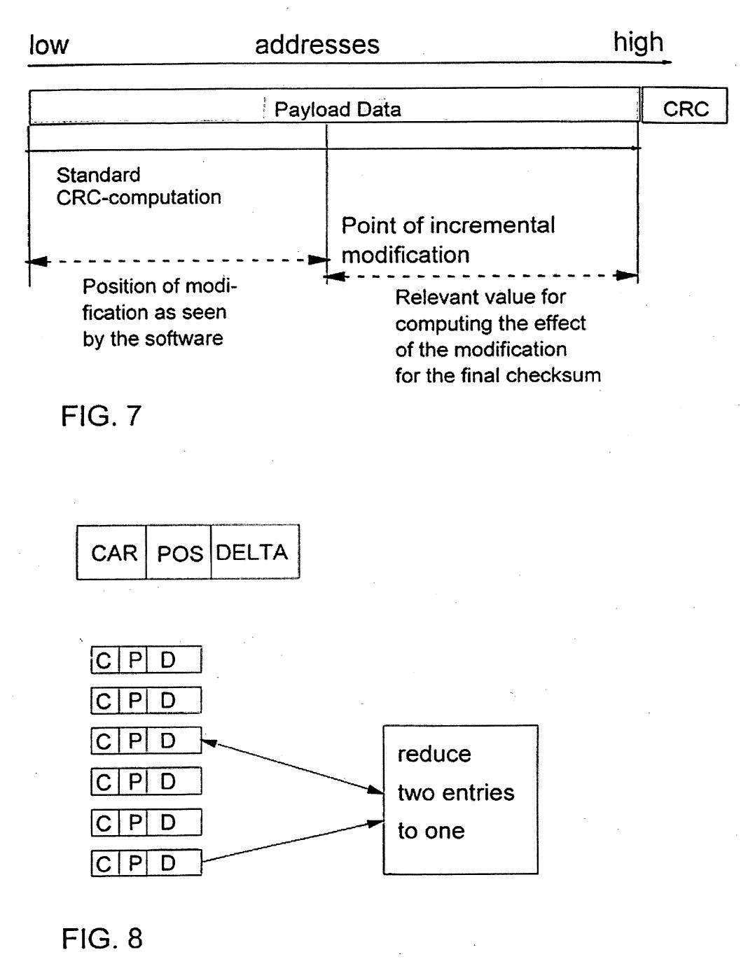

The FIG. 7 illustrates the motivation for the position management. The positional parameter c in the polynomial computation process commands refers to the distance of a word to the end of the prescribed checksum computation direction. This prescribed direction is defined by the application and frequently manifested in standards. However, for applications, it would be more convenient to provide the position of a modification as an address, i.e. in reverse direction, namely, as an offset from the start of the message. Therefore the computation process would need the length of the data block. For software modularity reasons this can be difficult, especially when the message needs to be processed in “cut-through” mode, i.e. before the entire message has been received. For each polynomial computation process, a position-related state maxpos is added and three operation modes are defined. To describe these operation modes, a command U(pos, d) is used. This is normally not visible from outside. It has three different interpretations depending on the mode. A C-like pseudo-code is used in the following table to describe the behavior of the U command in the different modes. The modes are described in more

| | Issued Polynomial | |
|---|---|---|
| Mode | Computation Command | Effect on maxpos |
| Explicit length | B(maxpos − pos, d) | none |
| End relative | B(pos, d) | maxpos never used |
| Auto length | if(pos > maxpos) | if(pos > maxpos) |
| | { F(pos − maxpos, d);} | { maxpos = pos;} |
| | else { B(maxpos − pos, d);} | |

detail in the table below.

In the explicit length mode, a mechanism is required to provide the length at the beginning of a computation. For instance, in some applications the length might be fixed while in other applications a dedicated command to set the length needs to be added.

In the end relative mode, the software measures all distances relative to the end, thus the method does not need to know the length.

In auto length mode, maxpos is initialized at the start of a computation with an appropriate value, which is typically 0, but at most the minimum length of the message. It should be noted, that the auto length mode can emulate the explicit length mode, if the length is provided at the beginning of a computation by an U(length, 0) command.

The selection of any of these modes can be supported by the unit according to the invention.

To reduce the number of parameters in the U(pos, d) command and to relieve the application from managing the position in a task 2 application, another level of management can be added which keeps another state, the current working position, pos. The following commands are provided at this level:
set_postition(newpos)

This command changes the internal position state pos to the new position value newpos. No polynomial computation process command is issued.
update(d)

This command issues the backward command B(pos, d) to the corresponding polynomial computation process.
update_ai(d)

This command is the same as the command update(d), but in addition the internal state pos is incremented by the size of a word, while “ai” stands for auto-increment.
update_ad(d)

This command is the same as the command update(d), but in addition the internal state pos is decremented by the size of a word, while “ad” stands for auto-decrement.

Only one of the update commands needs to be supported.

Basic Operational Units

On check polynomials two basic operations are defined, namely addition and multiplication of two polynomials. For the check polynomials typically used for checksums in a standard representation, the addition is equivalent to “exclusive or” operation.

A multiplication of two polynomials results in a polynomial of twice the degree. For checksum purposes, only the remainder after division by the generator polynomial is needed. Therefore, after multiplication the remainder by dividing through a polynomial can be used. This determination of the remainder is a ring homomorphism. Therefore, it is not necessary to execute it at the end of all updates, but it can be used after every multiplication resulting in a remainder polynomial with a degree smaller than the divisor polynomial. There are several methods how the remainder can be determined. The proposed invention can use any of these methods. If several polynomials are used, it is necessary that the reduction is universal and uses divider polynomial specific data. In particular, a matrix multiplication can be used.

If a polynomial with degree between the degree of the generator polynomial and twice the generator polynomial is given, a vector-matrix multiplication and an addition can be used to determine the remainder. The matrix needed for this step depends only on the divisor polynomial. It is generated only once before executing a number of operations with the same polynomial. Therefore, a means for performing a vector-matrix-multiplication is needed, either as hardware block or as software routine. This is a standard problem and many efficient methods are known. In particular, when applying the invention, a wide range of options for higher speed or lower hardware costs can be applied.

It is necessary to note that in many instances of the invention both the vector and the matrix have to be provided as flexible parameters to the vector-matrix-multiply unit. For using several polynomials at the same time, multiple options are proposed. One option is a memory where several matrices are stored. The matrices can be compressed in this memory, since typically successive rows will be similar (shifted by one digit). For typical 32-bit polynomials, which can be found for instance in the Autodin/Ethernet/ADCCP standards, the uncompressed matrix requires 32*31 bits=992 bits=124 Bytes. In the extreme case the matrix can be constructed from the polynomial. Since this construction requires some effort, it should be used only when the number of polynomials is high.

In a typical application where the polynomial is defined by the application for instance fixed by a standard, the matrix can be computed when the application is implemented. The content of the matrix memory can be filled from external storage. The matrix storage can be part of other memory in the device in which the invention is used. There can be several instances of the vector-matrix-multiplication means. These means can be used with the same matrix or with different matrices for working with different polynomials at the same time.

The separation of the two operations “polynomial multiplication” and “vector-matrix-multiplication” is only used here for clarity. For someone skilled in the art it is evident that they can be integrated into one unit making use of redundancies in functionality. If it should be decided that two distinct units should be implemented in a particular embodiment, they can be used in parallel in the invention by interleaving two or more expression paths. Reduction method for executing polynomial computation process commands

The main effort for performing the two basic commands in a polynomial computation process
F(c,d):v′:=v*x^{c}+d modulo p
B(c,d):v′:=v+d*x^{c} modulo p
is in the computation of the multiplications including determining the power x^{c}. To provide this result quickly, a combination of techniques is used. In the first place the multiplication and reduction operations can be implemented directly in hardware as introduced before. Secondly, a fixed set of precomputed powers (x^{c} modulo p) is stored in a memory for fixed scaling factors. The scaling factor memory consists of two interleaved banks 8.1 and 8.2 as shown in FIG. 9. Examples for this set of scaling factors are in multiple of digit-per-word units:
Powers of a fixed number, e.g. 2 or 4,
Fibonacci numbers,
an interval of natural numbers,
application-specific numbers, such as 48 for concatenation of ATM cells when using a byte unit addressing or
a combination of these sets.

Furthermore, in an optional power cache, which is not shown in FIG. 9, recently used powers can be stored. Wherever reference is made to processes accessing the fixed powers elsewhere in the description, this includes the cached powers. If for instance two backward commands B(f, d1) and B(f+1, d2) are executed in series, the power xf computed for the execution of the first command can be stored in the power cache and reused for the computation of the power x^{f+1}, i.e. it only needs to be multiplied by x¹ which is part of the fixed set of powers, either as 2⁰ or as one of the numbers of the Fibonacci sequence.

When using a generator polynomial lower than the word size, it can be required to do a multiplication and following reduction with a factor of 1, to force reduction of an input word. This can be the case if the last command results in a B( ) operation before the result is retrieved.

The input word can have degree equal w−1, wherein w is the word width, while the result should have a degree lower than the polynomial degree. By multiplying with 1 the related remainder is not changed, but the reduction is performed. In case of use of the reduction scheme, one can keep a status bit for every contribution triple which records whether the result is reduced or not. Alternatively one can investigate the degree of the remainder to determine whether the additional reduction is needed.

Reduction Engine

The reduction mechanism can be used in a high end implementation. It provides low latency for result retrieval if several parallel polynomial computation processes are used. Furthermore, it increases the performance even in the case of only one polynomial computation process if a high number of commands are processed before a result value is needed. The principle is that the distributive law is exploited as follows: Two given contributions to one polynomial A*X^{B} and C*X^{D}, are reduced to one contributor E*X^{F} by:
A*X^{B}+C*X^{D}=E*X^{F}(modulo p)
wherein
p is the generating polynomial and
F=min(B, D).
   If B>=D:
   E=A+C*X^{B-D}(modulo p)
   If B<=D:
   E=C+A*X^{D-B}(modulo p)

The factors X^{D-B} or X^{B-D} are computed by using the values from the power cache of previously used factors, and by the precomputed factors. This is the basic mechanism explained before. By continuously applying this series of computations on the set of currently outstanding contributions, the number of entries in this set is reduced by 1 for every computation process until the set has shrunk to a single element. To get the result, the position factor has then to be reduced to 0. This is again a basic reduction step. The reduction process is illustrated in FIG. 8. Every new command to the invention, like incorporate a modification to a data block in the checksum or append data blocks, is translated into triples of
1. The identification of the computation process which relates to the block CAR,
2. the position, which can be the address where the modification applies or the length of the appended block or similar. It represents a power of x in the residue ring pos and
3. the change relative to this position, which can be the difference of the new value and the old value. If a new block is constructed the old value is to be considered 0. Difference in this respect is polynomial subtraction which is an exclusive-or combination for the important case where the base field of the polynomial is GF(2), i.e. usual CRC checksums delta d.

When applying this method, a challenge in the selection of the two contributions is present. On a first level, the process (the accumulation register refers to) has to be selected. The following non-exhaustive options are available:
1. Fair selection: all processes are selected either with equal frequency or proportional to the number of entries waiting for reduction.
2. The process with the highest number of entries is selected. This reduces the latency if a final result is requested.
3. The application guides the selection by providing priorities or by signaling when it expects the result. The most urgent computation would be selected in this case.
4. The process where the computation is easiest, for instance, where a currently available cache value can be used.

Within one process a suitable pair has to be selected, if there is at least one entry which is not completely reduced. The careful selection of the order of combining these pairs can significantly reduce the total amount of computation required.

The methods have been only presented for the case of word width 32 and polynomial degree 64 but for someone skilled in the art it is clear how to apply this extension to any combination of polynomial degree and word size if the overall resources are sufficient.

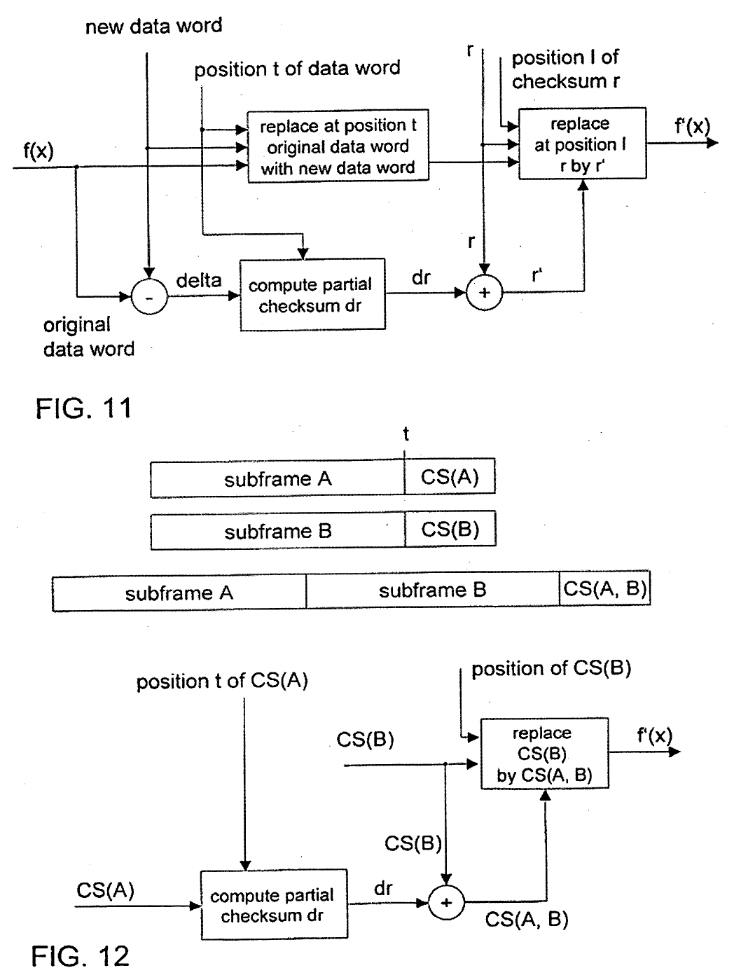

As shown in FIG. 9, the checksum computation unit comprises a preprocessing unit with inputs for the difference data delta, which can be determined in a way shown in FIG. 11, for the addresses corresponding to the difference data delta and for a car command. In a buffer or register 6.1 the maximum addresses maxpos for the individual checksum computation processes are stored. In a further register 6.2 the index of the different check polynomials may be stored. The FIFO registers 7 store different data from which checksums have to be computed. The real checksum computation takes place in the subordinated data path while the control of the data path is carried out in the core controller. Corresponding to the above made explanations the data, called values, are processed with the factors stored in the factor memories 8.1 and 8.2. After the polynomial multiplication carried out with the polynomial multiply unit 1, the reduction of the polynomial product carried out with the polynomial reduction unit 5 and adding the upper bits to the lower bits with a XOR 5.1 the reduced product is feed backwards to the input of the polynomial multiply unit 1. With this an iterative checksum calculation may be carried out. The final result in form of a final checksum is available at the circuit output 41.

The register 6.3 may store checksums which may be combined to form a final checksum. This is particularly helpful when for example a data frame shall be enlarged by several subframes. Therefore a checksum for each new subframe can be stored in the buffer 6.3. After computation of all checksums for all additional subframes, the checksums stored in the buffer 6.3 can be added to form the final checksum. The buffer 6.3 is also helpful when not only one but several sections in a data frame shall be altered. In this case, also all remainders for all altered sections are stored in the buffer. Afterwards the stored remainders are added to generate a final remainder representing the checksum for the new data frame.

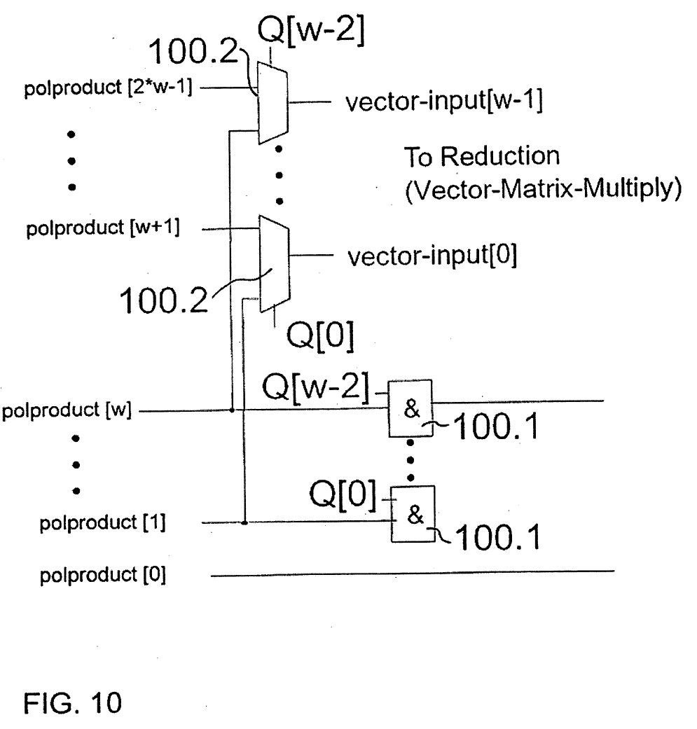

FIG. 10 shows an optional rotation unit with multiplexers 100.2 and AND gates 100.1 for a simpler handling of the product polynomials. The rotation unit can be inserted after the polynomial multiply unit 1. This is useful, when the invention is used with different polynomial degrees. In this case, the size of the lower product part and the upper product part according to the above mentioned step d) (split the product into an upper product part and a lower product part) should also vary. The size of the lower part can be as low as the degree of the currently used generator polynomial, while the upper product part consists of the remaining coefficients of the polynomial product. The polynomial product can have a maximum degree of the sum of the word size plus the degree of the generator polynomial minus 1. When the size of the lower part is fixed, this size has to be the minimum degree of all usable polynomials. This means that the length of the upper product part is in this case the sum of the word size minus one plus the difference of the maximum and minimum of the degrees of the supported polynomials.

This can have the disadvantage of requiring a large vector-matrix-multiply and a large matrix. For example, if the word width is 32 and polynomials with degrees of 8 and 32 are used, without a polynomial-dependent separation into the upper and lower product part the vector for reduction would have a length of 54. When the separation is programmable a vector or a length of only 31 is sufficient.

To separate both parts a unit similar to a so-called barrel shifter could be used. However, such a unit is costly. To avoid this cost, the fact can be exploited that the sequence of rows of the matrix—which correspond to individual polynomial product powers—can be positioned arbitrarily in the matrix. The rotation unit in FIG. 10 serves this purpose.

For digits i of the polynomial product below the word width, the corresponding result is either connected to same digit i in the lower product part or it is connected to the digit multiplied with the (i−1)th row of the matrix. For digits i equal or larger than the word width w, the corresponding result from the polynomial product is either ignored or it is connected to the input of the vector-matrix multiplier corresponding to row (1−w−1). FIG. 10 shows this for the case when the minimal supported polynomial degree is one. For a higher minimum degree fewer multiplexers are needed. The AND-gate, symbolized by the rectangle containing the sign “&”, represents a circuit for conditionally replacing an input value of the base field by zero.

Single-Instruction Multiple Data (SIMD) mode

The method and apparatus of the invention can be modified such that it can be used in an operating mode which allows parallel operation of the basic function when the degree of the generator polynomials is lower than the word width w. In this operating mode the input word, the scaling factors, the intermediate reduced products and so on are divided into independent parts. The independent parts do not have to relate to the same generator polynomial. In order to conserve the independence, the polynomial multiply unit 1 needs a modification to its original function. As known in the state of the art, a polynomial multiply generates partial products from the factor digits and sums the partial products belonging to the same result degree. In order to avoid contributions of non-related fractions of the factors corresponding to the SIMD-operation mode, some of the partial products have to be conditionally excluded from summation. In the case of a base field GF(2) the generation of a partial product can be done with a two-input AND-gate. The conditional exclusion of a partial product can be achieved by adding another input to such an AND-gate. This input receives a logic “1” in normal operation mode and a logic “0” in other modes. A similar modification can be done in other architectures of the polynomial multiply.

A second requirement for the SIMD operation mode requires a repositioning of the result digits of the polynomial product. Because the result is also partitioned into several individual products, the splitting into lower and upper product parts has to be done on each fraction of the polynomial product. The upper parts of the fractions are concatenated to form the input to the vector-matrix multiply and the lower parts are concatenated to form the input to the summation 5.1, denoted xor in FIG. 9.

The matrix multiply or polynomial reduction unit 5 can be used unmodified.

Depending on the application the factor memory can be split up into several memories 8.1 and 8.2 of smaller width as shown in FIG. 9 such that the factors for the fractions of a factor can be read independently. In this case the processes of the core controller need to be replicated such that the factors can be determined independently for the fractions of the factors.

In other applications always the same factors are applied to a partitioned input word and one set of controllers is sufficient.

The core controller illustrated in FIG. 9 contains at least one master process controller 20. The master process controller 20 determines which factors have to be processed, and generates the addresses for the reading the factors from the factor memories 8.1 and 8.2, as well as the control signals 26, 32, 28, 38, and 34. Since it can happen, that during the processing of one request according to the above mentioned steps a) to h) in some cycles the multipliers are not used, a higher performance can be achieved by starting a second, or third operation controlled by the slave process controller or controllers 19. When this is done, each process generates control signals 26, 28, 32, 34, 35, and 36. These control signals are combined using multiplexers 42, where every process signal whether its contribution is valid. In this way, the master process controller 20 and the slave processes controller 19 control different portions of the data path at the same time. For instance, the master processes controller 20 can multiply the reduced product from the XOR gate 5.1 with the value from data word register 18 by controlling the signals 28, 34 and using the multiplexer 17, while a slave process can read a factor from the factor memory 8.1 into the delay register 14 by controlling 35 and 26.

In the same way, clearing the checksum accumulation register 6.3 can be done when neither the slave processes controller 19 nor the master process controller 20 use the CAR by generating the selection of the checksum accumulation register 6.3 to be cleared and activating signal 23 (clr_car).

It is possible to exchange the reduction matrices and the factors for some polynomials in the memories 3, 8.1 and 8.2 while a computation using other polynomials is active. This is controlled by the reconfiguration process unit 24.1 which generates the signals for reconfiguration 24.11.

When a result is requested, the reading of the checksum accumulation register 6.3 has to be synchronized with the ongoing computations. It has to be guaranteed, that all previous requests contributing to the required results have been completed. Furthermore, depending on the priority (either high computation throughput or low latency for result retrieval) the access time for reading the result from the checksum accumulation register 6.3 has to be arbitrated with the accesses required by the computation processes controlled by the slave processes controller 19 and the master processes controller 20. This is the task of the CAR arbitration unit 43.

When the reduction matrix is stored in a compressed way requiring several steps for decompression, changing the polynomial when retrieving the next request from the request queue requires starting the decompression (signal 30). This is done by the decompress control unit 22. It observes the fill level of logical request queues 7, priorities which may be provided by the user or designer and outstanding result requests, do decide, with which polynomial the next computation should be carried out.

FIG. 11 illustrates a first embodiment of an application in which an original data word is replaced by a new data word using the checksum calculation unit according to the invention to recalculate the checksum. For example, if a data frame f(x) is transferred from a source terminal via a intermediate node to a destination node, it is necessary to alter the header of the data frame in the intermediate node. Furthermore, the checksum has to be recalculated. In FIG. 11 the original header is denoted as original data word and the new header is denoted as new data word. After the original data word has been subtracted (in GF(2) notation) from the new data word, the difference delta is led to the checksum calculation unit as illustrated in FIG. 9. The checksum calculation unit determines from delta a partial checksum dr and leads it to an adder. With the adder the partial checksum dr is added to the original checksum. The result is a new checksum r′, which is used to replace at the position of the original checksum the original checksum. With this finally a new data frame f′(x) arises.

FIG. 12 shows a second embodiment of an application in which a first subframe A with a checksum CS(A) is added to a second subframe B with a checksum CS(B) using the checksum calculation unit according to the invention to recalculate a checksum CS(A, B). Therefore, the checksum CS(A) and the position thereof are led to the checksum calculation unit according to the invention, which determines thereof a partial checksum dr and leads it to an adder (in GF(2) notation). With the adder the partial checksum dr is added to the checksum CS(B) of the subframe B. The result is a new checksum CS(A, B), which is used to replace at the position of the checksum CS(B) the checksum CS(B). With this finally a new elongated data frame f′(x) arises.

Extension for Use of Generator Polynomial of Higher Degree

So far the process of computations, caches has been described for a certain word width with the assumption that the degree of the generator polynomial is not larger than the word width. It is discussed in this section, how the resources for several computation processes and several polynomials can be used together to carry out computations in a remainder ring generated with a polynomial of higher degree than the basic word width of the basic operational units.

A first method is to use the memories 3, 8.1 and 8.2, the register set for flexibly handling several checksum computation processes and the memory with partially evaluated contributions in combination. Because all elements, like precomputed scaling factors, cached scaling factors and so forth occupy several words, the storage space dedicated for several polynomials has to be taken together to store the equivalent for a polynomial of higher degree. If for instance the basic word width is 32 and the check polynomials of degree 64 shall be used, from the memory of fixed scaling factors the amount which would be occupied by two polynomials of degree up to 32 is used together to store the scaling factor for the polynomial of degree 64.

For the reduction matrix memory 3 this approach can be modified. For a polynomial of degree 64 the reduction matrix would require four times the size of the reduction matrix for a 32 Bit polynomial. However, the reduction matrix is not an arbitrary matrix, instead, it has special properties. The reduction matrix R64 is defined such that
R64*A=A*x⁶⁴(modulo P64)
if P64 is the associated generating polynomial of degree 64 and this holds for any polynomial A. It should be noted, that on the left side of the equation A is interpreted as vector and on the right hand side as a polynomial. Because the matrix R64 is 4 times as large as a matrix for reduction of a polynomial of degree 32, 4 vector-matrix-multiplications are needed to reduce the result after the polynomial multiplication. However, the following equation uses only a 32 by 64 Bit matrix:
R64_{—}32*A=A*x³²(mod P64)

It has to be applied twice to do achieve the same reduction result. However, in total the same amount of 32×32-vector-matrix multiplications is required. The polynomial multiplication of degree 64 can be performed using 3 or 4 polynomial multiplications of degree 32 as well known in the literature, for instance D. E. Knuth “The Art of Computer Programming—Seminumerical Algorithms”.

Having illustrated and described a preferred embodiment for a novel method and apparatus for determining a remainder in a polynomial ring a method for updating the checksum, it is noted that variations and modifications in the method and the apparatus can be made without departing from the spirit of the invention or the scope of the appended claims.

### Reference Signs

1 polynomial multiply unit
3 memory
4 matrix decompression unit
4.1 current matrix register
5 polynomial reduction unit
5.1 XOR gate
6.1 register
6.2 register for check polynomial
6.3 register for checksums
7 FIFO registers
8.1 first fixed scaling factor memory
8.2 second fixed scaling factor memory
11 XOR gate
12 AND gate
13.1 first multiplexer
13.2 second multiplexer
14 register
15 register
16 result register for the checksum
17 multiplexer
18 data word register
19 slave
20 master
21 queue controller
22 decompress controller
23 clear CAR command
24.1 reconfigure process
24.11 reconfigure commands
24.2 clear CAR process
25 product register
26 select d1 command
27 enable d1 command
28 select f1 command
29 matrix_mem_a command
30 start decompression command
31 enable current matrix register command
32 select d0 command
33 enable d0 command
34 select f0 command
35 even factor command
36 odd factor command
37 value_car_mux command
38 select CAR command
39.1 first multiplexer
39.2 second multiplexer
40.1 factor register
40.2 factor register
41 checksum result
42 multiplexer
43 CAR arbitration unit

1. Method for determining a remainder in a polynomial ring, comprising the steps of:
a1) extract a value out of a quantity of values, in which each value has a certain position,
b) determine from the position of the first value a set of factors,
c) calculate the product from a first and a second factor, which are taken from the set of factors,
d) split the product into an upper product part and a lower product part,
e) reduce the upper product part by multiplying the upper product part with a reduction matrix,
f) join the lower product part and the result from step e) together to get a reduced product,
g) calculate the product from the reduced product and the next factor out of the set of factors,
h) repeat the steps d) to g) for all factors from the set of factors,
i) calculate the product from the reduced product and the extracted value,
j) repeat the steps d) to f), wherein the last preserved reduced product is the remainder in the polynomial ring.

2. Method according to claim 1,
comprising the further steps:
a0) before step a1) is worked off, a current remainder is initialized to a predefined constant value,
k) after step j) the last preserved reduced product is added to the current polynomial remainder, and
l) the steps a1) to k) are repeated until all values are exhausted.

3. Method according to claim 1,
wherein the factors are determined and stored in a factor memory before the calculation of the reduced product is started.

4. Method according to claim 2,
wherein the factors are determined and stored in a factor memory before the calculation of the reduced product is started.

5. Method according to claim 1,
wherein the preserved remainder in the polynomial ring is used as checksum.

6. Method according to claim 2,
wherein the preserved remainder in the polynomial ring is used as checksum.

7. Method according to claim 3,
wherein the preserved remainder in the polynomial ring is used as checksum.

8. Method for updating the checksum in a data frame,
including an original polynomial section to be replaced by a new polynomial section, comprising the steps of:
a) calculate the difference polynomial (delta) between the original polynomial section and the new polynomial section,
b) determine from the position of the original polynomial section a set of factors,
c) calculate the product from a first and a second factor, which are taken from the set of factors,
d) split the product into an upper product part and a lower product part,
e) reduce the upper product part by multiplying the upper product part with a reduction matrix,
f) join the lower product part and the result from step e) together to get a reduced product,
g) calculate the product from the reduced product and the next factor out of the set of factors,
h) repeat the steps d) to g) for all factors from the set of factors,
i) calculate the product from the reduced product and the polynomial difference (delta),
j) repeat the steps d) to f),
k) add the last preserved reduced product (dr) to the original checksum (r) to generate the updated checksum (r′).

9. Method for updating the checksum in a data frame,
including a first subframe (A) with a checksum CS(A) to be enlarged by a second subframe (B) with a checksum CS(B),
comprising the steps of:
a) determine from the position of the checksum CS(A) a set of factors,
b) calculate the product from a first and a second factor, which are taken from the set of factors,
c) split the product into an upper product part and a lower product part,
d) reduce the upper product part by multiplying the upper product part with a reduction matrix,
e) join the lower product part and the result from step e) together to get a reduced product,
f) calculate the product from the reduced product and the next factor out of the set of factors,
g) repeat the steps d) to f) for all factors from the set of factors,
h) calculate the product from the reduced product and the checksum CS(A),
i) repeat the steps d) to f),
j) add the last preserved reduced product (dr) to the checksum CS(B) to generate the updated checksum CS(A, B).

10. Apparatus for determining a remainder in a polynomial ring,
with a value buffer (18) for storing a polynomial value,
with a factor memory (8.1, 8.2) for storing factors,
with a polynomial multiply unit (1) connected to the factor memory (8.1, 8.2) for generating a polynomial product out of the factors and an input polynomial,
with a matrix multiply unit (5) connected to the polynomial multiply unit (1) for generating a reduced product with reduced polynomial degree by multiplying the polynomial product with a reduction matrix,
with a multiplexer means (13.1, 13.2, 17, 39.1, 39.2) for either conducting the reduced product or the polynomial value as the input polynomial to the to the polynomial multiply unit (1).

11. Apparatus according to claim 10,
with a matrix memory (3) for storing the reduction matrix.

12. Apparatus according to claim 11,
wherein the reduction matrix is stored as compressed reduction matrix in the matrix memory (3),
with a decompression unit (4) connected between the matrix memory (3) and the matrix multiply unit (5) for decompressing the compressed reduction matrix.

13. Apparatus according to claim 10,
with a buffer (6.3) for storing several remainders in polynomial rings,
with an adder (11) for adding the remainders.

14. Apparatus according to claim 11,
with a buffer (6.3) for storing several remainders in polynomial rings,
with an adder (11) for adding the remainders.

15. Apparatus according to claim 12,
with a buffer (6.3) for storing several remainders in polynomial rings,
with an adder (11) for adding the remainders.

16. Apparatus according to claim 10,
with a rotation unit connected between the polynomial multiply unit (1) and the matrix multiply unit (5) for mixing up the outputs of the polynomial multiply unit (1), if required.

17. Apparatus according to claim 11,
with a rotation unit connected between the polynomial multiply unit (1) and the matrix multiply unit (5) for mixing up the outputs of the polynomial multiply unit (1), if required.

18. Apparatus according to claim 12,
with a rotation unit connected between the polynomial multiply unit (1) and the matrix multiply unit (5) for mixing up the outputs of the polynomial multiply unit (1), if required.

19. Apparatus according to claim 13,
with a rotation unit connected between the polynomial multiply unit (1) and the matrix multiply unit (5) for mixing up the outputs of the polynomial multiply unit (1), if required.

20. Apparatus according to claim 14,
with a rotation unit connected between the polynomial multiply unit (1) and the matrix multiply unit (5) for mixing up the outputs of the polynomial multiply unit (1), if required.

21. Apparatus according to claim 15,
with a rotation unit connected between the polynomial multiply unit (1) and the matrix multiply unit (5) for mixing up the outputs of the polynomial multiply unit (1), if required.

22. A computer program product,
loadable into the internal memory of a digital computer,
comprising software code portions for performing the steps of:
a) extract a value out of a quantity of values, in which each value has a certain position,
b) determine from the position of the first value a set of factors,
c) calculate the product from a first and a second factor, which are taken from the set of factors,
d) split the product into an upper product part and a lower product part,
e) reduce the upper product part by multiplying the upper product part with a reduction matrix,
f) join the lower product part and the result from step e) together to get a reduced product,
g) calculate the product from the reduced product and the next factor out of the set of factors,
h) repeat the steps d) to g) for all factors from the set of factors,
i) calculate the product from the reduced product and the extracted value,
j) repeat the steps d) to f), wherein the last preserved reduced product is the remainder in the polynomial ring.
